(19) United States
(12) Patent Application Publication
(10) Pub. No.: US 2003/0207234 A1
(43) Pub. Date: Nov. 6, 2003

(54) Double headed orthodontic ligature pliers

(76) Inventors: Margo K. Brilliant, Miami, FL (US); Robert M. Schwartz, Miami, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/429,573

(22) Filed: May 5, 2003

Related U.S. Application Data
(60) Provisional application No. 60/377,875, filed on May 3, 2002.

(51) Int. Cl. A61C 3/14

(52) U.S. Cl. 433/159

(57) ABSTRACT

The present invention is an orthodontic ligature pliers, to facilitate engaging an orthodontic elastic ligature to an orthodontic bracket, which is attached to a patient's tooth allows the removal of two o-rings from an elastic ligature stick at a time, allowing the user to attach the two o-rings, each in a separate step to two brackets, without having to return to the o-ring stick allows the user to place two o-rings at the mouth on separate brackets, without having to return to the o-ring stick to replenish the o-ring after each previous o-ring is applied.

### CROSS-REFERENCE TO RELATED APPLICATION

This application claims the benefit of U.S. Provisional Patent Application Serial No. 60/377,875, filed on May 3, 2002, entitled DOUBLE HEADED ORTHODONTIC LIGATURE PLIERS.

### BACKGROUND OF THE INVENTION

1. Field of the Invention

The present invention is a double headed orthodontic ligature pliers and method for transferring more than one orthodontic elastic ligature at a time, to facilitate engaging an orthodontic elastic ligature (also referred to herein as an o-ring) to an orthodontic bracket, the latter attached to a patient's tooth. Instead of taking one o-ring at a time and attaching it to one bracket at a time, this invention allows the removal of two o-rings from an elastic ligature stick (also referred to herein as an o-ring stick) at a time, allowing the user to attach the two o-rings, each in a separate step to a bracket, without having to return to the o-ring stick. The invention doesn't tie two o-rings to brackets at the same time, but allows the orthodontic doctor, dental assistant, technician or other user (these terms are used interchangeably herein) to place two o-rings at the mouth on separate brackets, without having to return to the o-ring stick to replenish the o-ring after each previous o-ring is applied.

2. Description of the Related Prior Art.

Prior to the present invention, the orthodontist and the technicians or other dental assistants performing this procedure used ligature pliers having a conventional shape of two opposed plates (jaws) to grab an o-ring typically from an o-ring stick. The selected o-ring is pulled off the o-ring stick while clamped within the jaws of the ligature pliers, also known as a hemostat, to hold the o-ring until it is placed on a bracket, by stretching the o-ring over the bracket wings or posts. This required the technician to travel from the o-ring source, the ligature stick, to the patient's mouth once for each o-ring used on a bracket.

### SUMMARY OF THE INVENTION

The present invention is an improved ligature pliers and method to allow the orthodontist or other user, to grab and secure two o-rings at a time with the ligature pliers from an o-ring stick and then individually release the said secured o-rings from the ligature pliers, as the user attaches each individual o-ring to a bracket. These improvements allow placement of more than one o-ring, each on a respective bracket, before the user must return the ligature pliers to the elastic ligature source.

These and other aspects and features of the invention are described in more detail below and are illustrated in the accompanying drawings.

### BRIEF DESCRIPTION OF THE DRAWINGS

Referring to the drawings which are made a part hereof this application,

FIG. 1. is a side view of the present invention with the jaws in an open position.

FIG. 2. is a side view of the present invention with the jaws in a closed position securing two elastic ligators within the jaws.

FIG. 3. is a top view of the present invention without o-rings within the jaws.

FIG. 4. is a bottom view of the present invention of FIG. 3.

FIG. 5. is a rear view of the present invention.

FIG. 6. is a front view of the present invention similar to FIG. 2, shown in a clamped position with two o-rings within the grasp of the jaws 19, 20 and 21.

FIG. 7 is a top view of an o-ring stick with eleven o-rings releasably attached to each side of the stick.

FIG. 8 is a schematic view of tooth T, a bracket B, an archwire W and an o-ring 22.

FIG. 9. is a partial exploded view showing the special relationship of stick 24, jaws 19, 20 and 21 and o-rings 22 and 23.

FIG. 10 is a partial exploded view of an alternate embodiment for jaw 19 and member 16.

### DETAILED DESCRIPTION OF THE PREFERRED EMBODIMENT

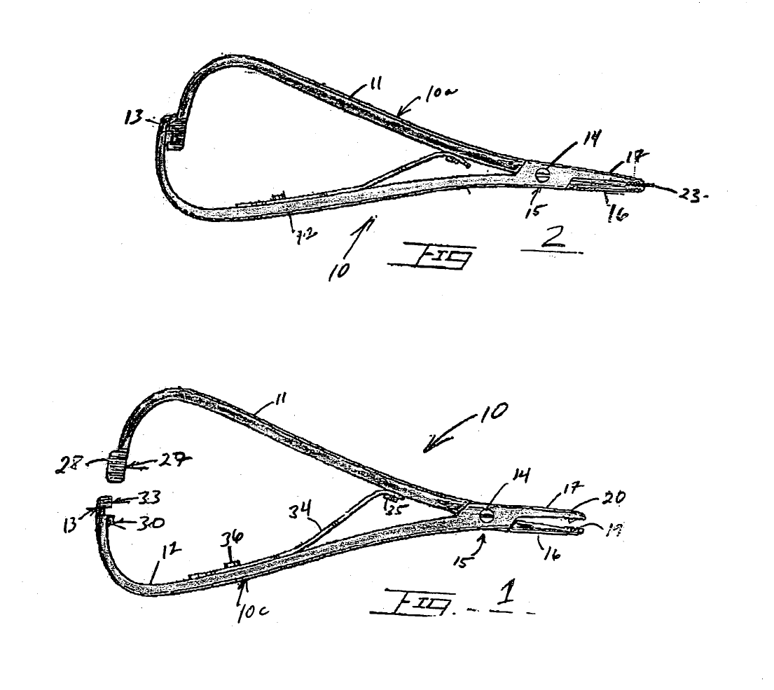

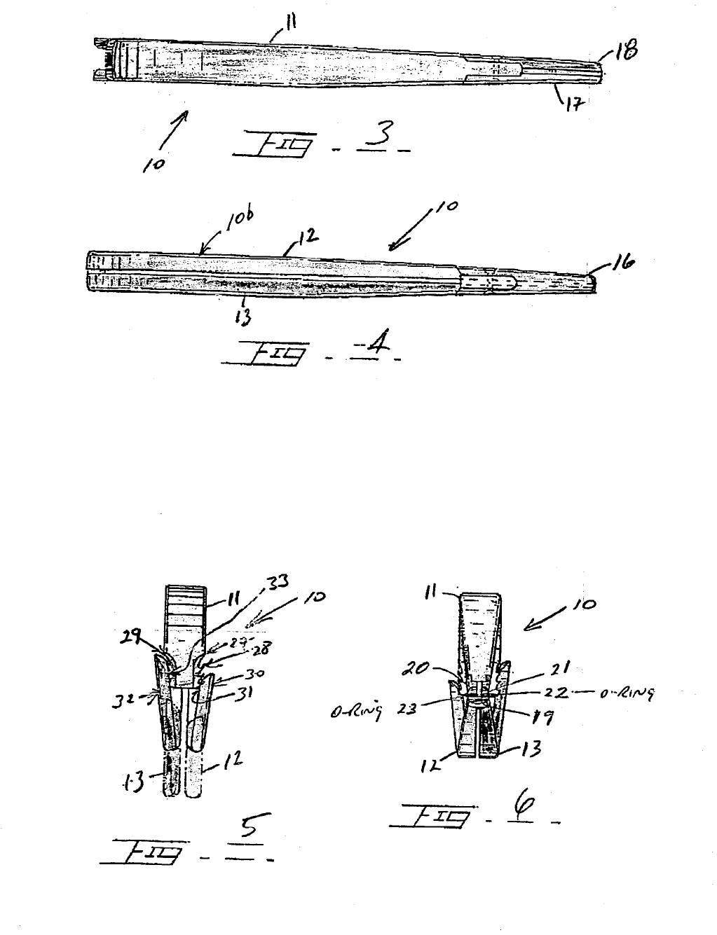

Referring to FIG. 1, the orthodontic ligature pliers 10 of the present invention are shown in an open position. Pliers 10 have elongated handle members 11, 12 and 13 pivotally connected by pivot pin 14 at pivot area 15. Handle members 16, 17 and 18 extend from pivot area 15 and form a first jaw 19, a second jaw 20 and a third jaw 21. Each said jaw 19, 20 and 21 has a generally flat serrated inner face surface. This surface increases the ability to grip an elastic o-ring. The inner surface of jaw 19 in the present invention is opposite and faces the inner surfaces of jaws 20 and 21.

Referring to FIG. 6, the ligature pliers 10 are in a clamped position holding two elastic ligatures. Inner face surface of jaw 20, which contacts a first o-ring 23, is opposite a portion of the inner face surface of jaw 19 which also contacts o-ring 23. Likewise, the inner face surface of jaw 21, contacts a second o-ring 22, is opposite a portion of the inner face surface of jaw 19 which also contacts o-ring 22. Jaws 19, 20 and 21 are constructed and arranged such that in a clamped position, jaw 19 will contact and grip two o-rings 22 and 23, in combination with jaw 20 which contacts and grips said o-ring 23, and jaw 21 will contact and grip the other said o-ring 22. Further, each o-ring can be gripped and then subsequently released independently of the other gripped o-ring. This independent operation is a result of the arrangement of handle member 11 on one side opposite handle members 12 and 13 such that said handle members 12 and 13 and their associated jaws 19, 20 and 21, operate independently of one another.

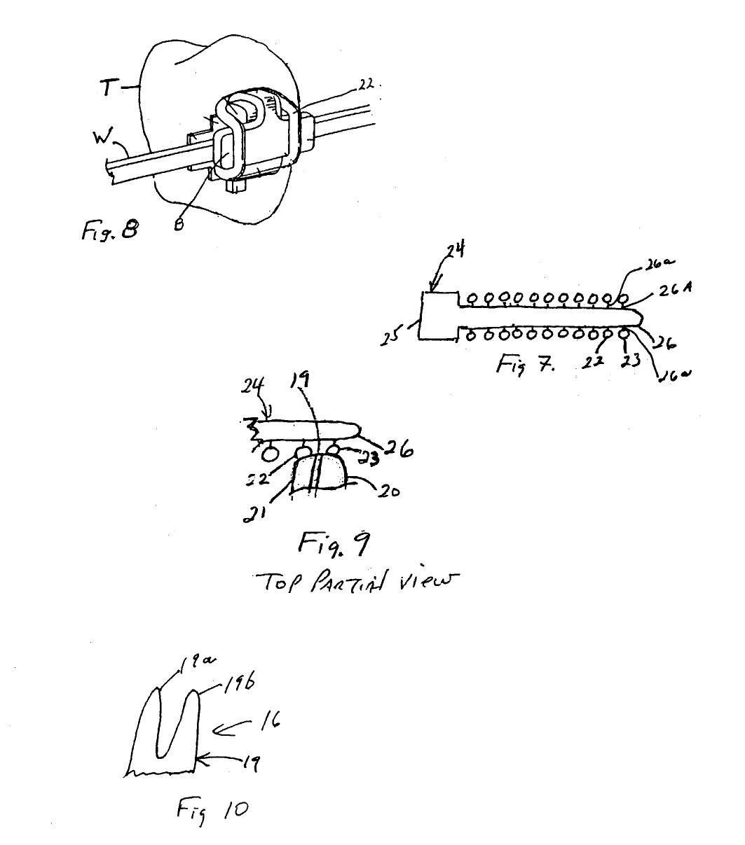

In the orthodontic practice, elastic ligatures 22 and 23, see FIG. 8, are manufactured for orthodontic use whereby each o-ring is separately and individually attached to an elongated ligature stick 24 commonly called an elastic ligature stick or o-ring stick, see FIG. 7. Ligature stick 24 includes a base portion 25 and an elongated portion 26. Individual O-rings e.g. o-ring 22 and o-ring 23, are attached on both sides of elongated portion 26 in a side by side arrangement. The o-rings are releasable because the attachment portion 26a is designed to break-off, such that each o-ring can be detached from elongated portion 26, preferably at the point where 26a attaches to the outer circumference of each individual o-ring.

In the present invention, any two of said o-rings that are side by side e.g. o-rings 22 and 23, using the present invention, can be gripped and removed from ligature stick 24 by said ligature pliers 10 as shown in FIG. 6.

Ligature pliers 10 include three lever arms pivoted together. A first lever arm 10a with handle member 11 at one end and member 16 at its other end, pivoted about pivot 15. Like-wise a second lever arm 10b with handle member 12 at one end and member 17 at its other end, is pivoted about pivot 15. A third lever arm 10c with handle member 13 at one end and member 18 at its other end, is pivoted about pivot 15. Said first lever arm 10a, said second lever arm 10b and said third lever arm 10c, with corresponding handles 11, 12 and 13 and members 16, 17 and 18, each pivot independently about pivot pin 14. Handle 11 of lever arm 10a is on one side and handles 12 and 13 of lever arms 10b and 10c are on the opposite side. Likewise, member 16 is opposite of members 17 and 18. Handles 12 and 13 and corresponding members 17 and 18, both opposite handle 11 and member 16 respectively, operate independently, such that jaw 19 of member 16 can engage jaws 20 and 21 of members 17 and 18 at the same time. Likewise jaw 19 can engage jaw 21 and not jaw 20. And as explained herein, jaw 19 will not engage either said jaws 20 and 21, when both said jaws 20 and 21 are released.

Therefore, two o-rings can be held and released independently of one another, such that in use the user will use ligature pliers 10 to simultaneously remove two o-rings from ligature stick 24 as set forth above. With ligature pliers 10 in an open first position, two o-rings 22 and 23 can be grabbed as follows: in the second position, o-ring 22 is grasped at its edge, near the outside circumference and held by jaw 19 and jaw 21, and at the same time, o-ring 23 is similarly grasped and held by jaw 19 and jaw 20. It can be noted that the width of jaw 19 must be sufficiently wide to contact two spaced apart o-rings attached to ligature stick 24. Likewise jaws 20 and 21 are spaced apart a sufficient distance to allow each said jaws 20 and 21 to independently contact and grip a separate o-ring.

In the second position, the user squeezes and moves handle 11 toward handles 12 and 13 so as to cause respective jaws 19 on one side and jaws 20 and 21 on the other side to grasp two o-rings 22 and 23.

In the third position, o-ring 22 is released independently, by operation of handle 13 operating independent of handle 12.

In the fourth position o-ring 23 is released by operation of handle 12.

By way of a background, the base of each handle 12 and 13 interact with the base of handle 11 by a separate ratchet means. The ratchet means used in the present invention allows a first handle and a second handle to close from an open to a closed position relative to and in relationship to a third handle.

Ratchet teeth on the first handle engage ratchet teeth on the third handle and ratchet teeth on the second handle engage teeth on the third handle to allow closing of the first and second handles relative to the third handle to be ratcheted together in a fixed relationship without exertion or additional closing pressure, while an operation is performed by the user of attaching an o-ring to a bracket. Thereafter, additional closing pressure on the first and second handles allow the ratcheted portions to pass one another to allow the first and third handles to release and return to an open position relative to one another, while maintaining the closed relationship of the second handle with the third handle while another said operation is performed by the user. Thereafter the additional closing pressure on the second and third handles allow the ratcheted portions to pass one another and return to an open position relative to one another.

Referring to FIG. 5, a novel part of the present invention, handle 13 is the first handle as heretofore described and handle 12 is the second handle, both said handles in relation to a third handle 11. In this arrangement, handles 12 and 13 operate independently of one another. Additionally, the interaction of ratchet combination of handles 11 and 13 release earlier than the interaction of combination of ratchets of handles 11 and 12. In this manner, in the second position, as previously described, two o-rings 22 and 23 are clamped as shown in FIG. 6, continued closing pressure applied by the user will cause the o-ring 22 gripped by handles 11 and 13 to release first, the third position. This allows the orthodontist to apply o-ring 22 to a first bracket and then release said o-ring 22 while maintaining the grip on o-ring 23 held by handles 11 and 12. In the fourth position, O-ring 23 is then applied to a bracket and then said handles 11 and 12 are further closed and then released relative to one another when the ratchets of handles 11 and 12 pass each other to be released and subsequently release o-ring 23. At this point the pliers 10 are open, in the first position as shown in FIG. 1, ready to repeat the cycle and grab two more o-rings.

Referring to FIGS. 1 and 5, at base 27 of handle 11, are two generally opposed ratchet portions 28 on one side and 29 on the other side. Base 30 of handle 12 has a ratchet portion 31. Likewise base 32 of handle 13 has ratchet portion 33. Spring means 34 is rigidly attached to the inside portion of handle 11 by nut 35 at one end. The other end of spring 34 has two ends, a first end slideably attached to the inside of handle 12 by nut 36 and a second end slideably attached to the inside of handle 13 (not shown). Spring 34 independently biases each handle 12 and 13 away from handle 11. This spring 34 bias acts against the closing pressure, by the user, when handles 12 and 13 are closed against handle 11 and spring 34 asserts the pressure to maintain the ratchet portions 31 and 28, and 29 and 33 in locked ratcheted positions until released.

In use, an orthodontist will typically apply approximately 20 new o-rings to a patient's brackets when both the upper and lower arch wires are replaced. When using the present invention, pliers 10 are used to secure two o-rings at a time from stick 24. It is also possible to secure or clamp only one o-ring if desired. Pliers 10 are placed perpendicular to elongated portion 26 putting jaw 19 to be in a position to clamp a first and second o-ring 22 and 23, such that jaw 21 clamps said first o-ring 22 on the opposite side of jaw 19 and jaw 20 clamps said second o-ring 23 on the opposite side of jaw 19. Handles 12 and 13 are squeezed and closed by the user toward handle 11 until all handles are in a first ratcheted position such that ratchet portions 29 and 33 are interlocked and ratchet portions 28 and 31 are interlocked. In this first ratcheted position, both o-rings 22 and 23 are securely clamped such that, pliers 10 grip o-rings 22 and 23 sufficiently strong enough to remove o-rings 22 and 23 from stick 24. As shown in FIG. 8, jaws 19 and 20 and jaws 19 and 21 grab an edge portion of o-rings 23 and 22 respectively leaving sufficient room to apply o-rings 23 and 22 to a bracket (FIG. 9).

After the o-rings are detached from the stick 24, both o-rings are clamped, then the orthodontist moves ligature pliers 10 from the stick 26 to the patient's mouth to apply the first o-ring 22 to a bracket. This is done in a customary manner as known in the art. Then the handles 12 and 13 are closed against handle 11 until handles 11 and 13 release—the ratcheted portions 29 and 30 pass one another—thus releasing the first o-ring 22. However, because the ratchet positions of handles 11 and 13 differ from the ratcheted positions of handles 11 and 12, such that just when the ratcheted portions of handles 11 and 13 release, the ratcheted portion of handles 11 and 12 remain ratcheted. In this second ratcheted position, the second o-ring 23 remains gripped so that second o-ring can now be placed on another bracket while keeping pliers 10 in the vicinity of the patient's mouth and without the necessity of the orthodontist or other user returning ligature pliers 10 to the ligature stick 24 to attach another o-ring. The second o-ring is attached to a desired bracket and handles 11 and 12 are squeezed and closed until the ratchet sections 28 and 31 release from one another. At this position the pliers are in an open position biased by spring 34 and are ready to repeat the cycle again of attaching two more o-rings, but having reduced the orthodontist's travel time from patient's mouth to o-ring stick 24 by approximately one half.

In maintaining the spirit of this invention, the beak area of jaws 19, 20 and 21 can assume different shapes, including that jaw 19, can have two beak portions 19a and 19b, shown in FIG. 10, instead of a single beak portion jaw 19. Each said beak portion would rigidly form member 16 attached to handle 11. One said portion 19a would line up opposite jaw 21 and the other portion 19b would line up opposite jaw 20. Additionally it is anticipated that handle 13 would appear in some manner different than handle 12 such that the user could easily identify the handle that would release the first o-ring. Each of the handles can be of a different color or other identifying means such as grip markings or modified surface markings and surfaces could also be used within the scope of the present invention to separately indicate handles 11, 12 and 13 from one another.

Although the disclosure set out herein is detailed in order to enable those skilled in the art to practice the invention, the embodiments disclosed herein are to be considered only examples of the invention which may be embodied in other specific structures as well.

Those skilled in the art will recognize that a number of other modifications to the invention are also possible. Accordingly, the invention should not be deemed limited to the specific embodiments described hereinabove and illustrated in the drawings, but instead only by a fair scope of the claims that follow along with their equivalents.

We claim:

1. A double headed ligature pliers comprising:
a first handle member;
a second handle member operationally engaged to said first handle member; and
a third handle member operationally engaged to said first handle member;
wherein said second handle member and said third handle member operate independently of one another.

2. A double headed ligature pliers as in claim 1, said first handle member having a first jaw member;
said second handle member having a second jaw member; and
said third handle member having a third jaw member;
wherein said second jaw member contacts said first jaw member independently of said third jaw member.

3. A double headed ligature pliers as in claim 1, further comprising:
said first handle member having a first jaw member;
said second handle member having a second jaw member; and
said third handle member having a third jaw member;
wherein said third jaw member contacts said first jaw member independently of said second jaw member.

4. A double headed ligature pliers as in claim 1, wherein said second jaw member and said third jaw member are capable of being locked into a position relative to said first jaw member.

5. A method of facilitating o-ring transport from a holder to brackets on a patient, said method comprising the steps of grabbing a plurality of o-rings between a first jaw member, a second jaw member and a third jaw member, wherein said o-rings are secured between said second jaw member and said third jaw member are capable of being locked into a position relative to said first jaw member.
